(19) United States
(12) Patent Application Publication
(10) Pub. No.: US 2010/0306244 A1
(43) Pub. Date: Dec. 2, 2010

(54) Method of the Combination of Patent Applicants or Patent Inventors in a Patent Analysis

(75) Inventors: LING GUO, Shanghai (CN); GUOZHU WEI, Shanghai (CN); XIANGDONG TANG, Shanghai (CN)

Correspondence Address: GLOBAL IP SERVICES, 7285 W. Eagle Court, Winton, CA, 95388, US

(73) Assignee: J.Z.M.C. Intellectual Property Data Science & Technology Co., Ltd., Shanghai (CN)

(21) Appl. No.: 12/554,944

(22) Filed: Sep. 7, 2009

(30) Foreign Application Priority Data
May 31, 2009 (CN) 200910052264.0

(51) Int. Cl. G06F 17/30; G06F 7/00

(52) U.S. Cl. 707/769; 707/803; 707/955; 707/812

(57) ABSTRACT

A method of the combination of patent applicants or patent inventors in a patent analysis comprises following steps: (a) creating a name database, which comprises a plurality of applicants' or inventors' name sheets and each of the name sheets includes different names of one applicant or one inventor; wherein each of the name sheets has a corresponding sheet title; (b) creating a thematic patent database of specific technical theme through patent searching among the patent literatures of all the countries in the world; (c) searching in the thematic patent database by using said sheet title as the search field, and matching applicants' or inventors' names in said thematic patent database with names in said name sheet, then marking the matched patents; and (d) combining names of applicants or inventors in said marked patents. The use of this method can improve the combination efficiency of patent applicants or patent inventors greatly.

### CROSS REFERENCE TO THE RELATED PATENT APPLICATION

The present application claims the priority of the Chinese patent application No. 200910052264.0 filed on May 31, 2009, which application is incorporated herein by reference.

### FIELD OF THE INVENTION

The present invention is related to a method of the combination of patent applicants or patent inventors in a patent analysis.

### BACKGROUND OF THE INVENTION

Patent analysis has been put more attention to by more and more enterprises. The analysis of patent applicants, namely competitors, has been becoming an important aspect in company's patent analysis.

However, there is a phenomenon that there are various forms of a name in patent INID code which are on behalf of the same enterprise. It is especially common in English patent literatures. There are two reasons for this occurrence generally. For one side, some big enterprises having good technical capacity apply for patents with unfamiliar names of subsidiary companies in order to avoid the attention of the public. As a result, other companies are apt to infringe upon patent rights without particular investigations. Then these big enterprises can obtain considerable compensation when their patent rights are infringed. For the other side, this phenomenon can mislead the competitors to do wrong judgments on the enterprise' technology direction and research direction. Therefore, it is necessary to combine applicant names which are actually of the same applicant in order to make a precious statistic analysis on the market information and technological information of the applicant. Because the inventor's names in different countries have differences through interpretation, we have to combine the inventor's names for the precious analysis on the technology roadmap of the inventor as well. So far, the combination of patent applicants or inventors has been carried out by manual operation on the basis of search results and judgments. It's a waste of time and labor cost and it tends to make mistakes in dealing with thousands of patent literatures. What's more, some applicants' technological fields have wide distribution. Consequently, it's possible to meet same applicants in different fields and the former work must be repeated which reduces the efficiency of the patent analysis to a great extent.

### SUMMARY OF THE INVENTION

A main objective of the present invention is to provide a method of the combination of patent applicants or patent inventors. This method can carry out the combination quickly and also partly save repeated work time, thus greatly improving the combination efficiency of applicants and inventors in the patent analysis.

The method of the present invention comprising the following steps:

(a) creating a name database, which comprises a plurality of applicants' or inventors' name sheets and each of the name sheets includes different names of one applicant or one inventor; wherein each of the name sheets has a corresponding sheet title;

(b) creating a thematic patent database of specific technical theme through patent searching among the patent literatures of all the countries in the world;

(c) searching in the thematic patent database by using said sheet title as the search field, and matching applicants' or inventors' names in said thematic patent database with names in said name sheet, then marking the matched patents; and

(d) combining names of applicants or inventors in said marked patents.

The combination of same applicants or inventors can start from step (b), skipping step (a), and then finish the combination with the next steps.

In a separate aspect of the present invention, the method further comprises the step of: combining the name database with the thematic patent database to form one database which is established and managed by using SQL SEVER OR ORCLE.

By using the technical solution of the invention, the efficiency of the combination of applicants and inventors are greatly increased and time is saved.

The details as well as other features of the present invention are set forth in the remainder of the specification and are shown in the accompanying drawings.

### BRIEF DESCRIPTION OF THE DRAWINGS

FIG. 1 is a schematic diagram showing main steps of the combination method of the present invention.

### DETAILED DESCRIPTION OF THE INVENTION

The present invention is described in detail in the following example.

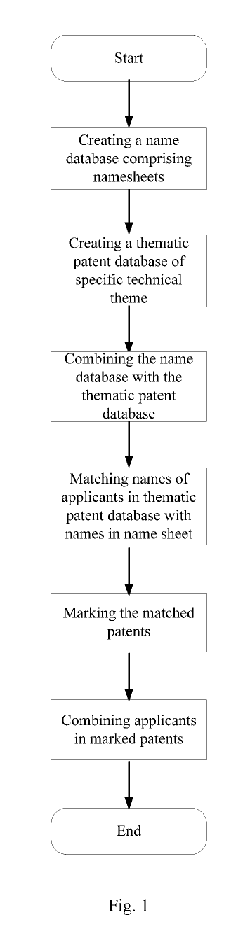

FIG. 1 is a schematic diagram showing main steps of the combination method of the present invention. Taking the technical theme “hydrogen engine of car” as example, the combination of applicants as TOYOTA includes the following steps:

First, creating a name database which comprises a plurality of applicants'/inventors' name sheets and each of the name sheets includes different names of one applicant/inventor, wherein each of the name sheets has a corresponding sheet title, such as TOYOTA, which possesses various names in its patent literatures INID code comprising TOYOTA MOTOR, TOYOTA JIDOSHOKKI KK, TOYOTA JIDOSHA KABUSHIKI KAISHA, TOYOTA CENTRAL RES & DEV LAB INC, TOYOTA AUTOM LOOM WORKS LTD, TOYODA CHUO KENKYUSHO KK and TOYODA AUTOMATIC LOOM WORKS; and integrating all these names in a name sheet of name database titled TOYOTA as a search field;

Second, creating thematic patent database of specific technical theme, e.g., hydrogen engine, through searching among the patent literatures of all the countries in the world, generally searching patent databases provided by China, America, Japan, England, France, German, Switzerland, European patent office, WIPO and etc., the addresses of which are familiar to those skilled in the art, thus forming hydrogen engine thematic patent database; alternatively, downloading data from the above patent databases to the local database and then searching in the local database to form hydrogen engine thematic patent database;

Third, combining the name database with the thematic patent database to form one database which is established and managed by using SQL SEVER or ORCLE or any other commercial database software;

Forth, searching in the thematic patent database by sheet title TOYOTA as the search field, and matching every name in the thematic patent database with the names in TOYOTA name sheet, then marking the matched patents with TOYOTA; and

Last, combining names of applicants in the patents marked as TOYOTA.

In the same way, we can skip step (a), and combine applicant TOYOTA in technical theme “hybrid vehicle” from step (b) to establish hybrid vehicle thematic patent database, then searching in the thematic patent database to finish combination of TOYOTA for hybrid vehicle.

According to the present invention, the combination of patent inventor TOYOTA could be done efficiently.

By using the technical solution of the invention, the efficiency of the combination of applicants and inventors are greatly increased and time is saved.

The embodiment described herein is merely illustrative of the principles of the present invention. It will be understood by one of ordinary skill in the art that various modifications can be made without departing from the spirit and the scope of the invention, as set forth in the appended claims.

What is claimed is:

1. A method of the combination of patent applicants or patent inventors in a patent analysis, comprising steps of:
(a) creating a name database, which comprises a plurality of applicants' or inventors' name sheets and each of the name sheets includes different names of one applicant or one inventor; wherein each of the name sheets has a corresponding sheet title;
(b) creating a thematic patent database of specific technical theme through patent searching among the patent literatures of all the countries in the world;
(c) searching in the thematic patent database by using said sheet title as the search field, and matching applicants' or inventors' names in said thematic patent database with names in said name sheet, then marking the matched patents; and
(d) combining names of applicants or inventors in said marked patents.

2. The method of claim 1, further comprising the step of combining said name database with said thematic patent database to form one database.

3. The method of claim 2, wherein said database is established and managed by using SQL SEVER or ORCLE.
